(19) United States
(12) Patent Application Publication
(10) Pub. No.: US 2013/0306608 A1
(43) Pub. Date: Nov. 21, 2013

(54) METHOD AND SYSTEM FOR CUTTING SHEET-LIKE OR PLATE-LIKE OBJECTS

(71) Applicant: Tim Schaefer, Harztor (DE)

(72) Inventor: Tim Schaefer, Harztor (DE)

(73) Assignee: Li-Tec Battery GmbH, Kamenz (DE)

(21) Appl. No.: 13/991,001

(22) PCT Filed: Nov. 29, 2011
(86) PCT No.: PCT/EP2011/005981

§ 371 Date: Aug. 7, 2013

(30) Foreign Application Priority Data
Dec. 3, 2010 (DE) 10 2010 053 341.6
Oct. 6, 2011 (DE) 10 2011 115 118.8

(51) Int. Cl. B23K 26/40

(52) U.S. Cl. CPC B23K 26/4095
USPC 219/121.67; 219/121.72

(57) ABSTRACT

What is described is: a method for cutting leaf-like or plate-like objects, in particular electrodes and/or separators for constructing an electrochemical energy store or parts of such electrodes or separators, wherein the cutting method has the following steps: (S1) leading the objects to be cut (1) up to a laser cutting apparatus (2), (S2) cutting the objects (1) with the laser cutting apparatus (2), and (S3) performing processing operations at the cutting edges (3) in order to reduce micro-short-circuits. The step (S3) of performing operations at the cutting edges (3) for reducing micro-short-circuits can comprise (S3a) structuring of the cutting edges (3) and/or application of support materials to the cutting edges (3). Also described is: a system (10) for cutting leaf-like or plate-like objects (1), in particular for cutting electrodes and/or separators for constructing an electrochemical energy store or parts of such electrodes or separators, wherein the cutting system (10) has a transport apparatus (5), which is designed to lead the objects (1) to be cut up to a laser cutting apparatus (2), a laser cutting apparatus (2) which is designed to cut the objects (1), and a processing apparatus (4, 5) which is designed to perform processing operations at the cutting edges (3) so as to reduce micro-short-circuits.

The entire content of the DE 10 2010 053 341.6 and DE 10 2011 15 118.8 priority applications are herewith referenced as an integral part of the present application.

The present invention relates to a method and a system for cutting sheet-like or plate-shaped objects, particularly for cutting electrodes and/or separators for the purpose of constructing an electrochemical energy storage or parts of such electrodes or separators.

Batteries (primary storage) and accumulators (secondary storage) composed of one or more storage cells are known as electrochemical energy storages, in which electrical energy is converted into chemical energy, and thus saved, in an electrochemical charge reaction between a cathode and an anode within or respectively between an electrolyte when a charge current is applied, and in which chemical energy is converted into electrical energy in an electrochemical discharge reaction when an electrical load is connected. As a rule, primary storage devices are thereby usually only charged once and disposed of after having been discharged while secondary storage devices allow for a plurality of charge and discharge cycles (from a few hundred 100 to more than 10,000). To be noted in conjunction hereto is that, particularly in the automotive sector, accumulators are also referred to as batteries.

A very large number of electrodes and separators are required, which is why high-quality, effective and economical manufacturing methods are needed. To be heeded when manufacturing electrodes and separators is that these components need to be cut into the appropriate dimensions in order to assemble an electrode stack or cells respectively. To enable a continuous production line, electrodes and separators are cut from electrode tapes, respectively separator tapes.

It is therefore an object of the present invention to provide an improved method and an improved system of cutting sheet-like or plate-shaped objects.

This object is accomplished by a method for cutting sheet-like or plate-shaped objects in accordance with claim 1 and a system for cutting sheet-like or plate-shaped objects in accordance with claim 18 as well as a battery in accordance with claim 23. Advantageous configurations and further developments constitute the subject matter of the dependent claims.

In accordance with a first aspect, the invention relates to a method of cutting. In the method for cutting sheet-like or plate-shaped objects, particularly electrodes and/or separators for the purpose of constructing an electrochemical energy storage or parts of such electrodes or separators, this object is accomplished by the cutting method comprising: the objects to be cut being advanced to a laser cutting apparatus, the laser cutting apparatus cutting the objects, and processing operations being performed at the cutting edges so as to reduce micro short-circuits. This configuration has the advantage of the cutting processes being able to be performed quickly and the cutting edges exhibiting the quality necessary for the intended future use since the processing operations can prevent or sufficiently reduce micro short-circuits at the cutting edges.

An “electrochemical energy storage” is to be understood in the present case as any type of energy storage from which electrical energy can be withdrawn, wherein an electrochemical reaction occurs within said energy store. The term encompasses energy storages of all types, particularly primary and secondary batteries. The electrochemical energy storage apparatus comprises at least one electrochemical cell, preferably a plurality of electrochemical cells. The plurality of electrochemical cells can be connected in parallel to store a greater charge or connected in series to achieve a desired operating voltage or can form a combined parallel and series connection.

Thus, an “electrochemical cell” thereby refers to an apparatus which serves in discharging electrical energy, wherein the energy is stored in chemical form. In the case of rechargeable secondary batteries, the cell is also designed to absorb electrical energy, convert it into chemical energy and store it. The design (i.e. particularly the size and geometry) of an electrochemical cell can be selected as a function of the available space. The electrochemical cell is preferentially of substantially prismatic or cylindrical form. The present invention is particularly advantageously applicable to those electrochemical cells referred to as pouch cells or coffee bag cells, without the electrochemical cell of the present invention being limited to such application.

Such an electrochemical cell typically comprises an electrode stack which is at least partially enclosed by a casing. In conjunction hereto, an “electrode stack” is to be understood as an assembly of at least two electrodes and an electrolyte arranged therebetween. The electrolyte can be partially accommodated by a separator, wherein the separator then separates the electrodes. The electrode stack preferably exhibits a plurality of electrode and separator layers, wherein the respective electrodes of like polarity are preferably electrically interconnected, particularly in parallel. The electrodes are for example of plate-shaped or film-like design and preferentially arranged substantially parallel to one another (prismatic energy storage cells). The electrode stack can also be coiled and exhibit a substantially cylindrical form (cylindrical energy storage cells). The term “electrode stack” is also to encompass such electrode coils. The electrode stack can comprise lithium or another alkali metal, also in ionic form.

In the context of the present invention, a “sheet-like or plate-shaped object” is to be understood as a substantially flat object, preferably a thin flat object. A flat object is thereby an object with its dimensions in a direction perpendicular to its surface area (also called the thickness direction) substantially smaller than the dimensions of its largest segment wholly within the surface area.

It is preferential for the method step of performing processing operations at the cutting edge for the purpose of reducing micro short-circuits to comprise the step of structuring the cutting edges. In this embodiment, the step of structuring the cutting edges preferably is performed with a laser structuring apparatus. One advantage of this configuration is that such structuring prevents micro short-circuits particularly quickly and effectively.

In one preferential embodiment, the step of structuring the cutting edges with the laser structuring apparatus is performed subsequent the step of cutting the object with the laser cutting apparatus. In another preferential embodiment, the step of structuring the cutting edges with the laser structuring apparatus is also performed prior to the step of cutting the object with the laser cutting apparatus. In these embodiments, it is preferential to use the laser cutting apparatus as the laser structuring apparatus for the step of structuring the cutting edges.

In accordance with a further preferential embodiment, the step of structuring the cutting edges with the laser structuring apparatus and the step of cutting the objects with a laser cutting apparatus are essentially performed simultaneously.

In accordance with a further preferential embodiment, the step of performing the processing operations at the cutting edges so as to reduce micro-short circuits comprises depositing support materials on the cutting edges. One advantage of this configuration is being able to support the cutting performed by a laser beam.

In this method, it is preferential for the step of applying support materials to the cutting edges and the step of cutting the objects with the laser cutting apparatus to be essentially performed simultaneously. Particularly preferential is for the support materials to comprise components having increased absorption coefficients in relation to the wavelengths used by the laser cutting apparatus.

In this method, it is preferential for the step of cutting the objects with the laser cutting apparatus to be performed such that at least a portion of the thermoplastic fibers fuse at the cutting edges.

In this method, it is preferential for the thermoplastic fibers to comprise a thermoplastic polyester, particularly polyethylene terephthalate.

In the method, the step of the laser cutting apparatus cutting the objects is preferentially performed at least partially with a pulsed laser exhibiting at least one of the following characteristics: a maximum wavelength in a wavelength range of from 400 nm to 1300 nm, preferably a maximum wavelength of 1070 nm, a pulse duration in a pulse duration range of from 5 ps to 200 ns, preferably a pulse duration of 30 ns, a frequency in a frequency range of from 40 kHz to 5000 kHz, preferably 250 kHz to 1000 kHz and in particular a frequency of 500 kHz, an overlap greater than 50%, preferably an overlap greater than 90%, a beam quality of <2 M²; an output in a power range of from 1 kW to 20 kW, preferably an output of 5 kW, and/or an effective laser focal spot smaller than 1000 μm, preferably an effective laser focal spot smaller than 300 μm.

In the method, the step of the laser cutting apparatus cutting the objects is preferentially performed at a cutting speed in a range of speed of from 0.01 m/s to 20 m/s, preferably in a range of speed of from 0.05 m/s to 6.0 m/s, and particularly preferentially in a range of speed of from 0.5 m/s to 4.0 m/s.

It is preferential in the method step of cutting the objects for the cutting edges of the objects to be seated over a slot of a slotted support.

In accordance with a second aspect, the invention relates to a cutting system. In the system for cutting sheet-like or plate-shaped objects, particularly for cutting electrodes and/or separators so as to construct an electrochemical energy store or parts of such electrodes or separators, this object is accomplished by the cutting system comprising a transport apparatus designed to advance the objects to be cut to a laser cutting apparatus, a laser cutting apparatus which is designed to cut the objects, and a processing apparatus designed to perform processing operations at the cutting edges so as to reduce micro short-circuits.

The processing apparatus preferentially comprises a laser structuring apparatus designed to structure the cutting edges. The processing apparatus can alternatively and/or additionally comprise a material depositing apparatus designed to deposit support materials on the cutting edges.

In the cutting system, it is preferential for the laser cutting apparatus to be designed to cut the objects such that at least a portion of the thermoplastic fibers fuse at the cutting edges.

It is preferential in the cutting system for the laser cutting apparatus to comprise a ytterbium fiber laser.

As regards the advantages of this cutting system and the terminology used, the explanations as given above in conjunction with the inventive cutting method apply accordingly.

The present invention also relates to an electric cell for an electrochemical energy storage apparatus having electrodes and/or separators which have been cut according to the above-cited cutting method and/or manufactured using such a cutting system as cited above.

Further advantages, features and possible applications of the present invention ensue from the following description in conjunction with the figures, which show:

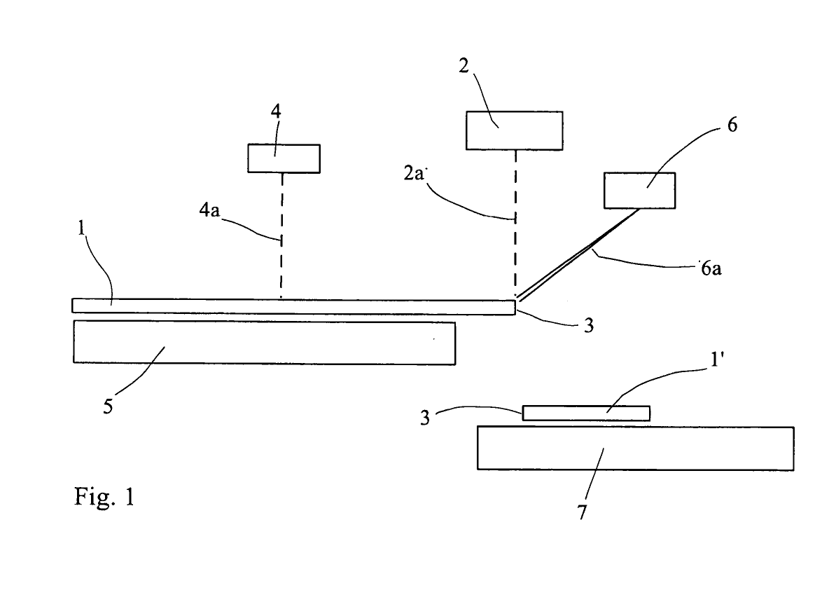

FIG. 1 a schematic depiction of a cutting system in accordance with one embodiment of the invention, and

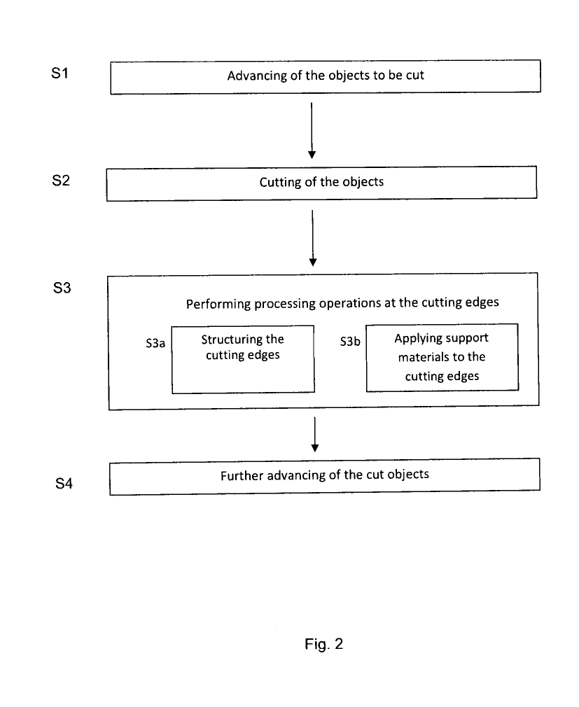

FIG. 2 a flow chart of a cutting method according to one embodiment of the invention.

The present invention will be described in the following using the example of cutting separators and electrodes for an electrochemical energy storage.

FIG. 1 shows a schematic depiction of a cutting system 10 according to one embodiment of the present invention. The cutting system 10 comprises a trans-port apparatus 5 which is designed to advance the separator tape 1 to be cut or the electrode tape 1 to be cut to a laser cutting apparatus 2. The laser cutting apparatus 2 cuts the separator tape 1 or the electrode tape at cutting edge 3 with a laser cutting beam 2a. FIG. 1 shows that the cutting operation can be supported by a material beam 6a from the material depositing apparatus 6 to the cutting edge 3. FIG. 1 further shows a laser structuring apparatus 4 able to structure the separator tape 1 or the electrode tape at the cutting edge 3 by means of a laser structuring beam 4a. After the cutting operations, the transport apparatus 7 further transports the separators 1′ cut from the separator tape 1, or the electrodes cut from the electrode tape respectively, out of the cutting system 10.

FIG. 2 shows a flow chart of a cutting method according to one embodiment of the present invention. In step S1, the separator tape 1 to be cut is advanced to the laser cutting apparatus. In step S2, the separators 1′ are cut from the separator tape 1, wherein processing operations are performed at the cutting edges 3 in step S3 in order to reduce micro short-circuits. According to the embodiment shown in FIG. 2, step S3 is performed after step S2. However, according to another embodiment not shown in FIG. 2, it is also possible for steps S2 and S3 to be performed simultaneously. According to a further embodiment not shown in FIG. 2, it is also possible for step S3 to be performed prior to step S2. FIG. 2 shows that step S2 of performing processing operations at the cutting edges 3 can comprise a structuring of the cutting edges 3 and/or an application of support materials to the cutting edges 3.

### LIST OF REFERENCE NUMERALS

1 object to be cut
2 laser cutting apparatus
2a laser cutting beam
3 cutting edge
4 laser structuring apparatus
4a laser structuring beam
5 transport apparatus
6 material depositing apparatus
6a material beam
7 ejecting apparatus
10 cutting system
S1 advancing of the objects to be cut
S2 cutting the objects
S3 performing processing operations at the cutting edges
S3a structuring the cutting edges
S3b applying support materials to the cutting edges
S4 further advancing the cut objects

1. A method for cutting sheet-like or plate-shaped objects (1), particularly electrodes and/or separators for the purpose of constructing an electrochemical energy storage or parts of such electrodes or separators, wherein the cutting method comprises the steps:
(S1) advancing the objects (1) to be cut to a laser cutting apparatus (2),
(S2) cutting the objects (1) with the laser cutting apparatus (2), and
(S3) performing processing operations at the cutting edges (3) so as to reduce micro short-circuits.

2. The method according to claim 1, characterized in that the step (S3) of performing processing operations at the cutting edges (3) so as to reduce micro short-circuits comprises:
(S3a) a structuring of the cutting edges (3).

3. The method according to claim 2, characterized in that the step (S3a) of structuring the cutting edges (3) is performed with a laser structuring apparatus (4).

4. The method according to claim 3, characterized in that the step (S3a) of structuring the cutting edges (3) with the laser structuring apparatus (4) is performed subsequent the step (S2) of cutting the object (1) with the laser cutting apparatus (2).

5. The method according to claim 3, characterized in that the step (S3a) of structuring the cutting edges (3) with the laser structuring apparatus (4) is performed prior to the step (S2) of cutting the object (1) with the laser cutting apparatus (2).

6. The method according to claim 4, characterized in that the laser cutting apparatus (2) of step (S2) is used as the laser structuring apparatus for the step (S3a) of structuring the cutting edges (3).

7. The method according to claim 3, characterized in that the step (S3a) of structuring the cutting edges (3) with the laser structuring apparatus (4) and the step (S2) of cutting the objects (1) with the laser cutting apparatus (2) are essentially performed simultaneously.

8. The method according to claim 1, characterized in that the step (S3) of performing processing operations at the cutting edges (3) for the purpose of reducing micro-short circuits comprises:
(S3b) depositing support materials on the cutting edges (3).

9. The method according to claim 8, characterized in that the step (S3b) of depositing support materials on the cutting edges (3) and the step (S2) of cutting the objects (1) with the laser cutting apparatus (2) are essentially performed simultaneously.

10. The method according to claim 8, characterized in that the support materials comprise components having increased absorption coefficients in relation to the wavelengths used by the laser cutting apparatus (2).

11. The method according to claim 1, characterized in that the sheet-like or plate-shaped objects (1) comprise thermoplastic fibers as supporting material.

12. The method according to claim 11, characterized in that the step (S2) of cutting the objects (1) with the laser cutting apparatus (2) is performed such that at least a portion of the thermoplastic fibers fuse at the cutting edges (3).

13. The method according to claim 11, characterized in that the thermoplastic fibers comprise a thermoplastic polyester, particularly polyethylene terephthalate.

14. The method according to claim 1, characterized in that the step (S2) of cutting the objects (1) with the laser cutting apparatus is performed at least partially with a pulsed laser which exhibits at least one of the following characteristics:
a maximum wavelength in a wavelength range of from 400 nm to 1300 nm, preferably a maximum wavelength of 1070 nm,
a pulse duration in a pulse duration range of from 5 ps to 200 ns, preferably a pulse duration of 30 ns,
a frequency in a frequency range of from 40 kHz to 5000 kHz, preferably 250 kHz to 1000 kHz and in particular a frequency of 500 kHz,
an overlap greater than 50%, preferably an overlap greater than 90%,
a beam quality of <2 M²,
an output in a power range of from 1 kW to 20 kW, preferably an output of 5 kW,
an effective laser focal spot smaller than 1000 μm, preferably an effective laser focal spot smaller than 300 μm.

15. The method according to claim 1, characterized in that the step (S2) of cutting the objects (1) with the laser cutting apparatus is performed at a cutting speed in a range of speed of from 0.01 m/s to 20 m/s, preferably in a range of speed of from 0.05 m/s to 6.0 m/s, and particularly preferentially in a range of speed of from 0.5 m/s to 4.0 m/s.

16. The method according to claim 1, characterized in that in the step (S2) of cutting the objects (1), the cutting edges (3) of the objects (1) are seated over a slot of a slotted support (8).

17. The method according to claim 1, characterized in that a ytterbium fiber laser is used in step (S2) of cutting the objects (1).

18. A system (10) of cutting sheet-like or plate-shaped objects (1), particularly of cutting electrodes and/or separators for the purpose of constructing an electrochemical energy store or parts of such electrodes or separators, wherein the cutting system (10) comprises:
a transport apparatus (5) designed to advance the objects (1) to be cut to a laser cutting apparatus (2),
a laser cutting apparatus (2) designed to cut the objects (1), and
a processing apparatus (4, 5) designed to perform processing operations at the cutting edges (3) so as to reduce micro short-circuits.

19. The cutting system (10) according to claim 18, characterized in that the processing apparatus comprises a laser structuring apparatus (4) designed to structure the cutting edges (3).

20. The cutting system (10) according to claim 18, characterized in that the processing apparatus comprises a material depositing apparatus (6) designed to deposit support materials on the cutting edges (3).

21. The cutting system (10) according to claim 18, characterized in that the laser cutting apparatus (2) is designed to cut the objects (1) such that at least a portion of the thermoplastic fibers fuse at the cutting edges (3).

22. The cutting system (10) according to claim 18, characterized in that the laser cutting apparatus (2) comprises a ytterbium fiber laser.

23. A battery comprising electrodes and/or separators, particularly a battery designed for use in motor vehicles, subject to a method in accordance with claim 1.
